(19) United States
(12) Patent Application Publication
(10) Pub. No.: US 2023/0271190 A1
(43) Pub. Date: Aug. 31, 2023

(54) DEVICES AND METHODS FOR FLOW CELL ASSEMBLY AND DISASSEMBLY

(71) Applicant: 10x Genomics, Inc., Pleasanton, CA (US)

(72) Inventors: Hendricus MARINDRA, Pleasanton, CA (US); Denis Pristinski, Dublin, CA (US); David Morgan, San Leandro, CA (US); Siyuan Xing, Newark, CA (US)

(21) Appl. No.: 18/175,885

(22) Filed: Feb. 28, 2023

Related U.S. Application Data
(60) Provisional application No. 63/314,714, filed on Feb. 28, 2022.

(51) Int. Cl. B01L 9/00

(52) U.S. Cl. CPC B01L 9/00; B01L 2200/025; B01L 2200/04

(57) ABSTRACT

Devices (e.g., flow cell holders) and methods for flow cell assembly and disassembly are provided. The flow cell holders and methods can be used to join or separate the bottom and top layers of a flow cell.

### BACKGROUND

Reversible flow cells are commonly used when a user would like to access the inside surface of the flow cell after running fluidic operations or to conserve the flow cell components (e.g., flow cells made of expensive or difficult to assemble components). A flow cell that can be sealed and opened without damaging the sample may also be useful for spatial related applications. For example, such a flow cell can be used to decode arrays on a wafer, which needs to be released and cut to an appropriate shape for further processing or analysis. Manual assembly and disassembly of a reversible flow cell may be difficult, as multiple pieces may need to be properly aligned prior to assembly, and excess force may damage fragile pieces.

Accordingly, devices (e.g., flow cell holders) and methods for assembling and disassembling flow cells would be beneficial.

### BRIEF SUMMARY

In general, the present disclosure relates to flow cell holders and methods for assembling and disassembling a flow cell using the flow cell holders.

In one aspect, a flow cell holder is provided. The flow cell holder includes a receptacle configured to hold a flow cell including a bottom layer and a top layer; and a separation mechanism including one or more actuators (e.g., 1, 2, 3, 4, 5, 6, 7, 8, 9, 10, 11, 12, 13, 14, 15, 16, 17, 18, 19, 20, or more actuators) operatively coupled to two or more separators (e.g., 2, 3, 4, 5, 6, 7, 8, 9, 10, 11, 12, 13, 14, 15, 16, 17, 18, 19, 20, or more separators). Each has a body with an angled tip and is disposed about the perimeter of the receptacle. Actuation by the one or more actuators (e.g., 1, 2, 3, 4, 5, 6, 7, 8, 9, 10, 11, 12, 13, 14, 15, 16, 17, 18, 19, 20, or more actuators) causes the separators to move substantially towards or away from the perimeter of the receptacle in a substantially uniform manner.

In some embodiments, the one or more actuators (e.g., 1, 2, 3, 4, 5, 6, 7, 8, 9, 10, 11, 12, 13, 14, 15, 16, 17, 18, 19, 20, or more actuators) include a lever having an effort side and a resistance side. The resistance side of the lever is mechanically coupled to the two or more separators (e.g., 2, 3, 4, 5, 6, 7, 8, 9, 10, 11, 12, 13, 14, 15, 16, 17, 18, 19, 20, or more separators), and movement of the effort side actuates the two or more separators. In some embodiments, each separator is attached to the flow cell holder via a pivot point, and moving the effort side of the lever moves each separator around the pivot point. In some embodiments, the separation mechanism includes three separators.

In some embodiments, the receptacle is between 6 and 9 cm (e.g., between 6.5 and 8.5 cm, between 6.75 and 8.25 cm, between 7 and 8 cm, between 7.25 and 7.75 cm, between 7.3 and 7.7 cm, between 7.4 and 7.6 cm, between 7.45 and 7.55 cm, between 6 and 8 cm, between 7 and 9 cm, between 6 and 7 cm, between 8 and 9 cm, between 6 and 7.5 cm, between 7.5 and 9 cm, about 6 cm, about 6.25 cm, about 6.5 cm, about 6.75 cm, about 7 cm, about 7.1 cm, about 7.2 cm, about 7.3 cm, about 7.4 cm, about 7.5 cm, about 7.6 cm, about 7.7 cm, about 7.8 cm, about 7.9 cm, about 8 cm, about 8.25 cm, about 8.5 cm, about 8.75 cm, or about 9 cm) in cross sectional dimension, e.g., diameter. In some embodiments, the receptacle is about 7.5 cm in cross sectional dimension, e.g., diameter.

In some embodiments, the tips are angled between 24° and 36° (e.g., between 25° and 35°, between 26° and 34°, between 27° and 33°, between 28° and 32°, between 28.5° and 31.5°, between 29° and 31°, between 29.5° and 30.5°, between 24° and 33°, between 27° and 36°, between 24° and 27°, between 33° and 36°, between 24° and 30°, between 30° and 36°, about 24°, about 25°, about 26°, about 27°, about 28°, about 29°, about 29.5°, about 29.75°, about 30°, about 30.25°, about 30.5°, about 31°, about 32°, about 33°, about 34°, about 35°, or about 36°). In some embodiments, the tips are angled at about 30°

In some embodiments, the flow cell holder further includes one or more alignment features (e.g., 1, 2, 3, 4, 5, 6, 7, 8, 9, 10, 11, 12, 13, 14, 15, 16, 17, 18, 19, 20, or more alignment features) disposed at the outer edge of the receptacle. In some embodiments, the flow cell holder includes two alignment features. In some embodiments, the flow cell holder further includes an alignment clamp configured to apply a clamping force on a flow cell disposed in the receptacle towards the one or more alignment features (e.g., 1, 2, 3, 4, 5, 6, 7, 8, 9, 10, 11, 12, 13, 14, 15, 16, 17, 18, 19, 20, or more alignment features).

In one aspect, a method of assembling a flow cell is provided. The method includes providing a flow cell holder described herein; inserting a bottom layer of the flow cell into the receptacle; placing the separators over a portion of the bottom layer; inserting a top layer of the flow cell into the receptacle, wherein the separators are disposed between the bottom layer and the top layer of the flow cell; and moving the separators away from the receptacle, thereby bringing the bottom layer and the top layer of the flow cell into contact.

In some embodiments of the method, the flow cell holder has one or more alignment features; and after the top layer of the flow cell is inserted into the receptacle a clamping force is applied to the flow cell towards the one or more alignment features.

In one aspect, a method for disassembling a flow cell is provided. The method includes providing a flow cell holder described herein, wherein the receptacle contains a flow cell having a bottom layer and a top layer; and moving the separators toward the flow cell to apply a wedging force between the bottom layer and the top layer of the flow cell, thereby disassembling the flow cell.

In some embodiments of the method, the flow cell holder has one or more alignment features; and a clamping force is applied to the flow cell towards the one or more alignment features.

In some embodiments, disassembly of the flow cell includes inserting the separators between the bottom layer and the top layer of the flow cell; and inserting the separators between the bottom layer and the top layer of the flow cell, e.g., by moving the separators through actuation of the actuators of the device.

In some embodiments, in any of the methods described herein, the separators of the flow cell holder are vertically disposed at substantially the same height as the interface between the bottom layer and the top layer of the flow cell in the receptacle.

In some embodiments of any aspect of the disclosure, the separators are blades, e.g., having a blade body and a blade tip, e.g., wherein actuation by the one or more actuators (e.g., 1, 2, 3, 4, 5, 6, 7, 8, 9, 10, 11, 12, 13, 14, 15, 16, 17, 18, 19, 20, or more actuators) causes the blade bodies and tips to move substantially towards or away from the perimeter of the receptacle in a substantially uniform manner.

### BRIEF DESCRIPTION OF THE DRAWINGS

FIG. 1 illustrates an exemplary device (e.g., flow cell holder).

FIG. 2A and FIG. 2B illustrate two views of a separator of the exemplary flow cell holder of FIG. 1.

FIG. 3A-FIG. 3C illustrate a method of assembling a flow cell having a bottom layer and a top layer using an exemplary flow cell holder of FIG. 1.

FIG. 4A and FIG. 4B illustrate a method of disassembling a flow cell having a bottom layer and a top layer using an exemplary flow cell holder of FIG. 1.

FIG. 5A and FIG. 5B illustrate an exemplary flow cell containing a notch with a shape complementary to the shape of a tip of a separator.

### DETAILED DESCRIPTION

The present disclosure provides devices (e.g., flow cell holders) and methods for assembling and disassembling a flow cell (e.g., a flow cell having a bottom layer and a top layer). The flow cell holders and methods of using them are designed to orient, align, assemble and/or disassemble a flow cell (e.g., a reusable flow cell) without damaging any flow cell components or any sample(s) enclosed within.

### Definitions

The following definitions are provided for specific terms: Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value. The term “sample,” as used herein, generally refers to a biological sample of a subject. The biological sample may be a nucleic acid sample or protein sample. The biological sample may be derived from another sample. The sample may be a tissue sample, such as a biopsy, core biopsy, needle aspirate, or fine needle aspirate. Tissue samples may originate from organs, including, but not limited to, eye, brain, lymph node, lung, heart, liver, kidney, stomach, intestine, colon, bladder. The sample may be fresh, frozen, fixed (e.g., with an aldehyde (e.g., formalin, paraformaldehyde, glutaraldehyde) or with an alcohol (e.g., methanol or ethanol), and/or paraffin-embedded. The sample may be a skin sample. The sample may be a cheek swab.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

### Flow Cell Holder

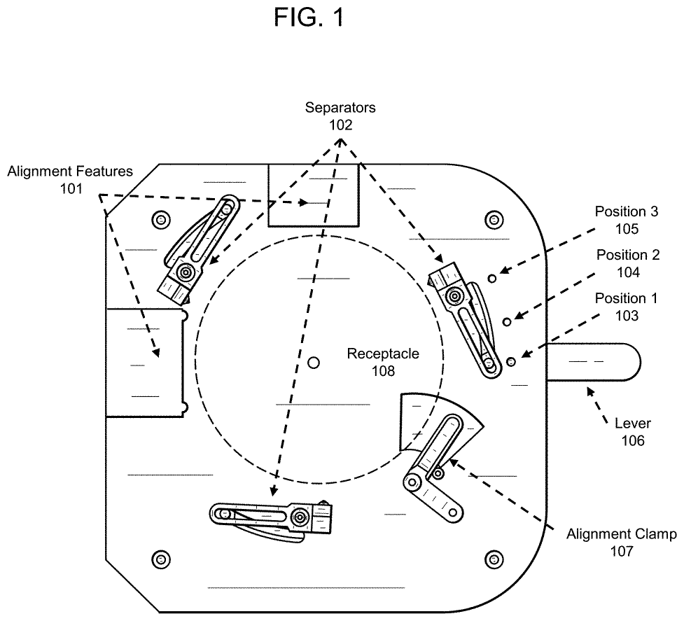

The flow cell holders described herein can be used to assemble or disassemble a flow cell, e.g., a flow cell having a bottom layer and a top layer. A flow cell holder includes a receptacle, e.g., for holding a flow cell and a separation mechanism. The separation mechanism includes one or more actuators (e.g., levers) operatively coupled to two or more separators, each having a body with an angled tip. The two or more separators are disposed about the perimeter of the receptacle, and actuation of the one or more actuators causes the separators to move substantially towards or away from the perimeter of the receptacle in a substantially uniform manner. The flow cell holder may further include one or more alignment features and one or more alignment clamps. An exemplary flow cell holder has a separation mechanism with a single actuator (e.g., lever) operatively linked to three separators, two alignment features, and an alignment clamp, as shown in FIG. 1. The exemplary flow cell includes two alignment features (101), three separators (102), a lever (106), an alignment clamp (107), and a receptacle (108). The exemplary flow cell includes three positions (i.e., Position 1 (103), Position 2 (104), and Position 3 (105)) to which the lever can be actuated.

The receptacle may be any size or shape suitable for holding a flow cell to be assembled or disassembled with the flow cell holder. For example, the receptacle may be circular in shape to hold a circular flow cell or rectangular in shape to hold a rectangular flow cell. The receptacle may also be roughly the same size as the flow cell. In some instances, the receptacle is between 6 and 9 cm (e.g., between 6.5 and 8.5 cm, between 6.75 and 8.25 cm, between 7 and 8 cm, between 7.25 and 7.75 cm, between 7.3 and 7.7 cm, between 7.4 and 7.6 cm, between 7.45 and 7.55 cm, between 6 and 8 cm, between 7 and 9 cm, between 6 and 7 cm, between 8 and 9 cm, between 6 and 7.5 cm, between 7.5 and 9 cm, about 6 cm, about 6.25 cm, about 6.5 cm, about 6.75 cm, about 7 cm, about 7.1 cm, about 7.2 cm, about 7.3 cm, about 7.4 cm, about 7.5 cm, about 7.6 cm, about 7.7 cm, about 7.8 cm, about 7.9 cm, about 8 cm, about 8.25 cm, about 8.5 cm, about 8.75 cm, or about 9 cm) in cross sectional dimension, e.g., diameter. In some instances, the receptacle is about 7.5 cm in cross sectional dimension, e.g., diameter. The receptacle may include a depression in which the bottom layer is disposed. Alternatively, the receptacle may be an area of the surface of the flow cell holder.

The separation mechanism of a flow cell holder may have one or more actuators (e.g., 1, 2, 3, 4 5, 6, 7, 8, 9, 10, 11, 12, 13, 14, 15, 16, 17, 18, 19, 20, or more actuators) and two or more separators (e.g., 2, 3, 4, 5, 6, 7, 8, 9, 10, 11, 12, 13, 14, 15, 16, 17, 18, 19, 20, or more separators). The separators may be actuated individually or in groups and synchronously or asynchronously. The one or more actuators may be manually operated or automated. In one example, a flow cell holder may have a single actuator and/or three separators. In some instances, the one or more actuators may be a lever or may be operatively connected to a lever having an effort side and a resistance side, wherein the resistance side of the lever is mechanically coupled to the two or more separators. Movement of the effort side of the lever actuates the two or more separators, e.g., to move the separators substantially towards or away from the perimeter of the receptacle. In some instances, each separator may be attached to the flow cell holder via a pivot point, and moving the effort side of the lever moves each separator around the pivot point, thereby moving the separators (e.g., the tips of the separators) towards or away from the perimeter of the receptacle. For example, the lever may be connected to a ring mounted on a bearing, where each of the separators is attached to the ring at a distance from the pivot point. Rotational movement of the lever then actuates the separators. Other actuators may employ any other suitable mechanism, e.g., motors, springs, threads, etc.

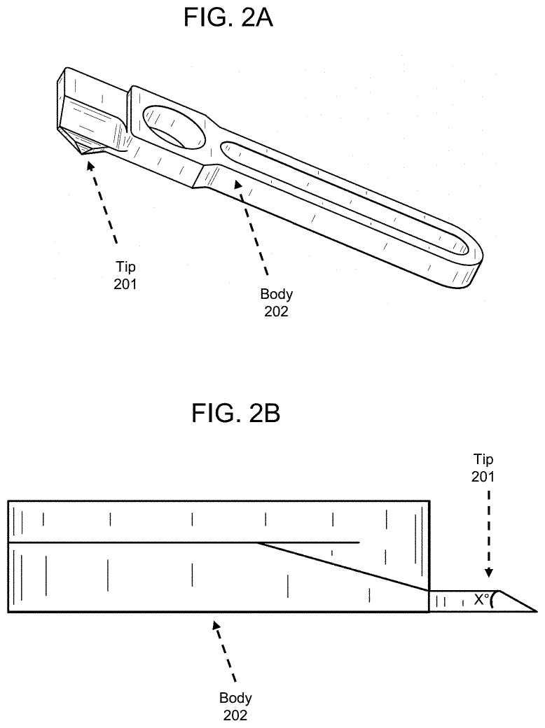

Diagrams of an exemplary separator are shown in FIG. 2A and FIG. 2B. In some instances, tips, e.g., of the separators, (201) are angled between 24° and 36° (e.g., between 25° and 35°, between 26° and 34°, between 27° and 33°, between 28° and 32°, between 28.5° and 31.5°, between 29° and 31°, between 29.5° and 30.5°, between 24° and 33°, between 27° and 36°, between 24° and 27°, between 33° and 36°, between 24° and 30°, between 30° and 36°, about 24°, about 25°, about 26°, about 27°, about 28°, about 29°, about 29.5°, about 29.75°, about 30°, about 30.25°, about 30.5°, about 31°, about 32°, about 33°, about 34°, about 35°, or about 36°). For example, tips may be angled at about 30°. The tip angle refers to the angle of the vertical incline of the tip (see, e.g., the angle denoted “X° ” in FIG. 2B). Tips of the separators point substantially towards the perimeter of the receptacle, i.e., towards the position where a flow cell is held or is to be held. Other than the tip angle, the bodies (202) and tips (201) of the separators of the flow cell holders may be of any suitable size and shape. For example, any of the length, width, and/or height of the bodies and/or tips may be between 1 mm to 20 cm in size (e.g., between 1 mm and 5 mm, between 5 mm and 1 cm, between 1 cm and 5 cm, between 5 cm and 10 cm, between 10 cm and 20 cm, between 1 mm and 1 cm, between 1 cm and 10 cm, between 5 cm and 20 cm, about 1, 1.5, 2, 2.5, 3, 3.5, 4, 4.5, 5, 5.5, 6, 6.5, 7, 7.5, 8, 8.5, 9, or 9.5 mm, or about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20 cm).

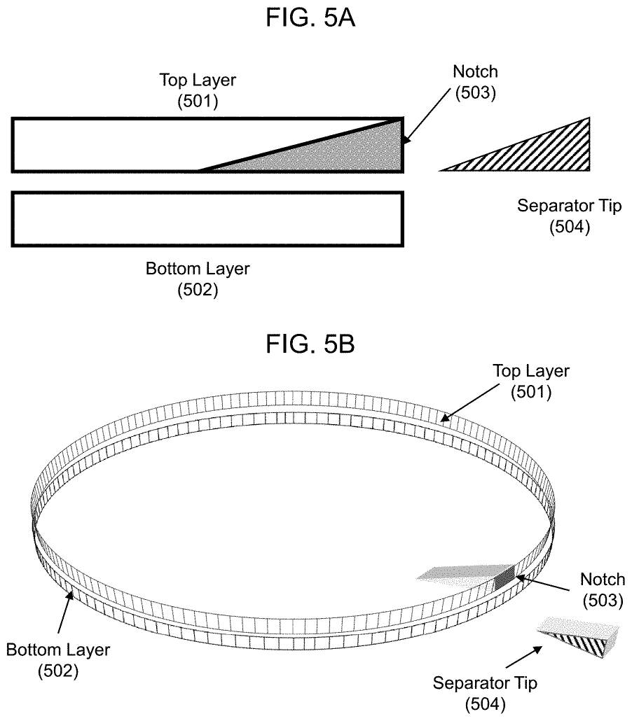

The tip of the separator may be of any suitable shape. For example, the tip of the separator may be wedge-shaped, triangular, pyramidal, cylindrical, conical, or needle-shaped. In some instances, a tip may include a slope that is curved or linear. Examples of suitable tips for separators include, but are not limited to, wedges, blades, and needles. The separator may be shaped such that when its tip is brought into contact with the top layer, bottom layer, and/or the interface therebetween, a wedging force is applied. The separator may transfer the wedging force into two opposing forces normal to the top layer and bottom layer and cause separation of the top layer and the bottom layer. The edge of the flow cell may include a void for the tip of the separator, e.g., in a complementary shape. The void may be formed solely in one layer (e.g., only in the top layer or only in the bottom layer) or be formed by the top and bottom layers of the flow cell combined. The void may allow for the force to be first applied inward of the outer edge of the flow cell. In one example (see FIG. 5A and FIG. 5B), the top layer (501) includes a void (e.g., a notch (503)) with a right triangular cross section along the axis of the tip (504) of the separator. The tip (504) of the separator has the corresponding cross section. When the tip (504) enters the notch (504), the bottom of the tip may slide along the top surface of the bottom layer (502) until the tip fills the notch (503) and exerts a wedging force. Any other similarly paired shapes of tips and notches may be employed, and the shapes need not exactly correspond to one another. Separators can be made from any suitable material, including, but not limited to, plastics, metals, silicates, minerals, etc., or a combination thereof, that can be shaped into the desired shape.

The shape of the body may also be any suitable shape and may be of a width and thickness to allow for operation of the holder. The shape of the tip and body may or may not be similar. In some embodiments, the separator may be substantially the same as the tip and may substantially not include a body. In some embodiments, the separator is blade having a blade body and a blade tip.

A flow cell holder may further include one or more alignment features (e.g., 1, 2, 3, 4, 5, 6, 7, 8, 9, 10, 11, 12, 13, 14, 15, 16, 17, 18, 19, 20, or more alignment features) disposed at the outer edge of the receptacle. In a particular example, the flow cell holder has two alignment features. Alignment features include raised features (e.g., blocks) against which the flow cell can be clamped. Other examples of alignment features include, but are not limited to, pins, posts, protrusions, ridges, prongs, etc., that are brought into contact with or inserted into the flow cell and provide a physical barrier to movement. Alignment features and flow cells may have complementary features.

The flow cell holder may further include one or more alignment clamps (e.g., 1, 2, 3, 4, 5, 6, 7, 8, 9, 10, 11, 12, 13, 14, 15, 16, 17, 18, 19, 20, or more alignment clamps) configured to apply a clamping force on a flow cell (e.g., both the bottom and top layers of a flow cell) disposed in the receptacle, e.g., towards the one or more alignment features (e.g., 1, 2, 3, 4, 5, 6, 7, 8, 9, 10, 11, 12, 13, 14, 15, 16, 17, 18, 19, 20, or more alignment features). In a particular example, a flow cell holder has a single alignment clamp. Alignment clamps may include e.g., springs, latches, screws, clips, rubber bands, ties, snaps, adhesives (e.g., glue), magnets, or a combination thereof, to apply the clamping force and maintain contact between the flow cell layers and the alignment features. Suitable springs for use in alignment clamps include tension springs, extension springs, flat springs, serpentine springs, torsion springs, volute springs, elliptic or semi-elliptic springs, mainsprings, etc.

The flow cell holders described herein may include any suitable material. Additionally, flow cell holders described herein are designed to hold and help assemble and/or disassemble flow cells having a bottom layer and a top layer made from any suitable material. Examples of suitable material include polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, as well as inorganic materials, such as silicon, or other silica based materials (e.g., glass, quartz, fused silica, borosilicate glass), metals, ceramics, and combinations thereof.

### Methods for Flow cell Assembly and Disassembly

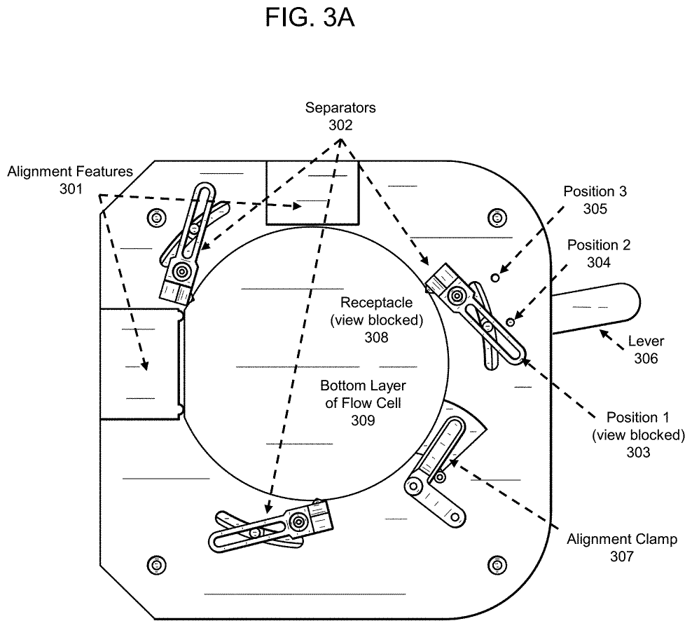

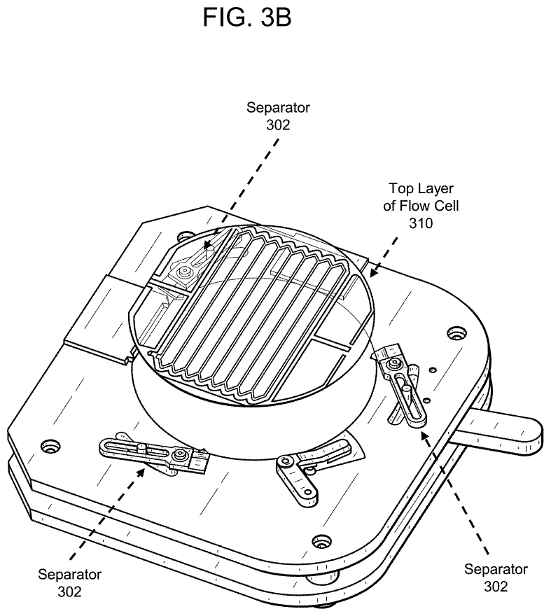

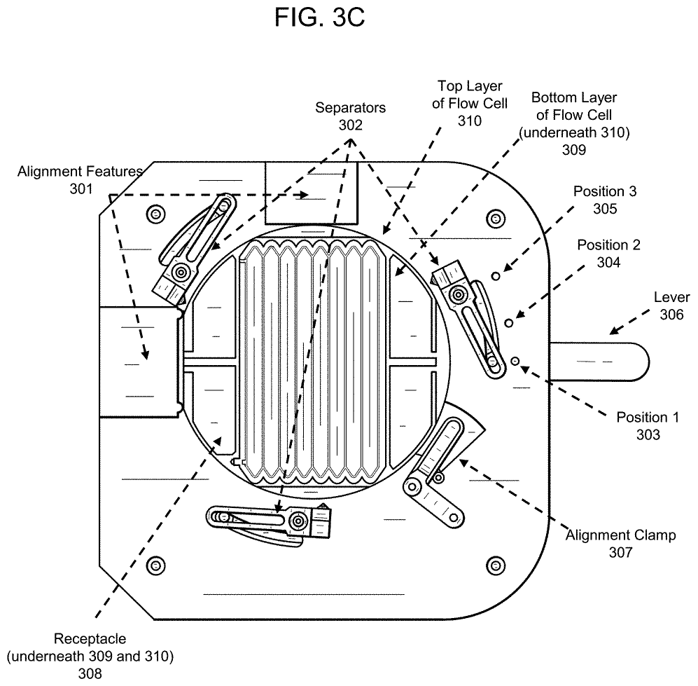

The methods described herein can be used to assemble a flow cell (e.g., a flow cell having a bottom layer and a top layer). The methods include placing the bottom layer and the top layer of the flow cell sequentially into the receptacle, aligning the bottom and top layers relative to each other and within the receptacle (e.g., by using the one or more alignment features and/or alignment clamp(s)), and using the separators (e.g., blades) as spacers between the bottom and top layers while bringing the bottom and top layers into contact by actuating the actuator(s) of the separation mechanism (e.g., a lever) to move the separators, and thus the tips of the separators, away from the perimeter of the receptacle and out of the space between the bottom and top layers of the flow cell. To align the bottom and top layers during flow cell assembly, a clamping force may be applied to the bottom layer and top layer of the flow cell in the direction of the one or more alignment features (e.g., in a substantially horizontal direction). FIG. 3A-FIG. 3C are a series of schematics demonstrating an exemplary method of flow cell assembly with the exemplary flow cell holder shown in FIG. 1.

For example, to assemble a flow cell having a bottom layer and a top layer, the bottom layer of the flow cell (309) is first inserted into the receptacle (308) and aligned with the alignment features (301), with the lever (306) at position 1 (303). The lever (306) is then actuated to position 2 (304) to place the tips of the separators (302) over a portion of the bottom layer of the flow cell (309), as shown in FIG. 3A.

The top layer of the flow cell (310) is then inserted into the receptacle (310), sandwiching the tips of the separators (302) between the bottom layer (309) and the top layer (310), as shown in FIG. 3B. Next, a clamping force is applied to the flow cell (e.g., the bottom and top layers of the flow cell) towards the alignment features (301) to align the bottom (309) and top (310) layers. Optionally, this clamping force is applied by actuating the alignment clamp (307) to align the bottom (309) and top (310) layers of the flow cell. In particular, the bottom (309) and top (310) layers are aligned relative to each other and also aligned relative to the positions of the three tips of the three separators (302). Lastly, as shown in FIG. 3C, the lever is actuated to position 1 (303) to move the separators (302) away from the receptacle (308) and to bring the bottom (309) and top (310) layers of the flow cell into contact, assembling the flow cell.

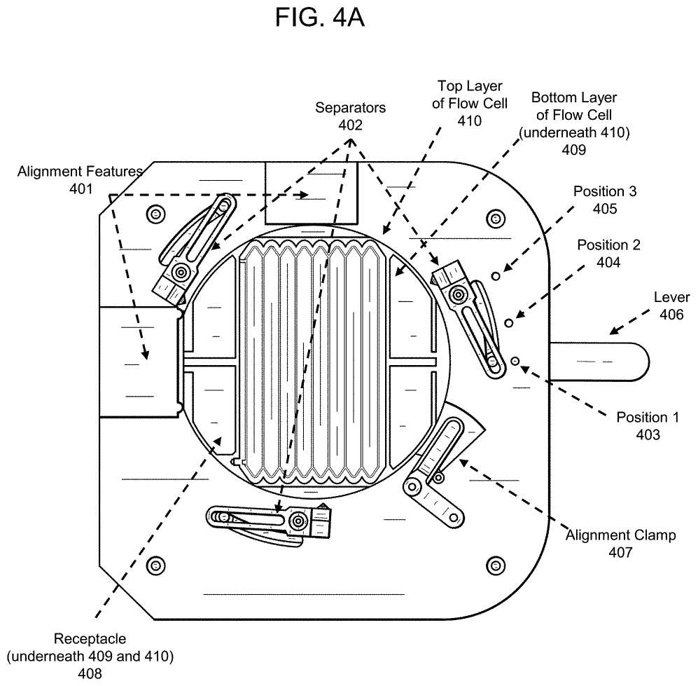

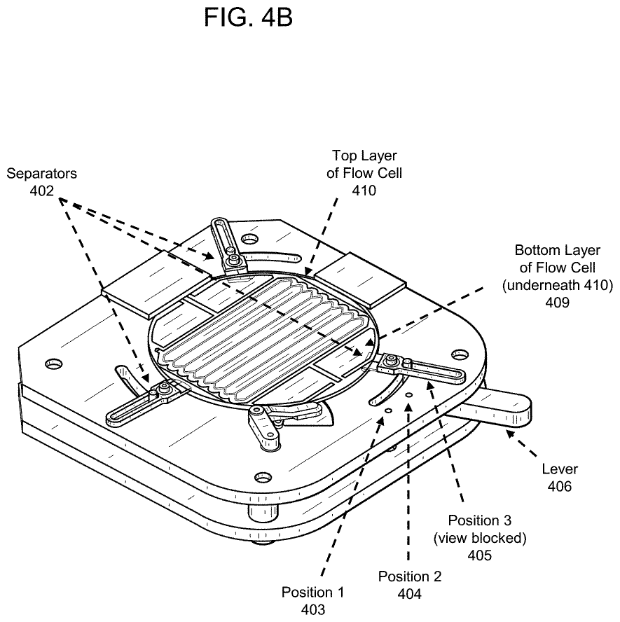

Disassembly of a flow cell employs the reverse process. The separators are used to apply a wedging force between the bottom and top layers to separate the bottom and top layers of the flow cell. Actuating the actuator(s) of the separation mechanism (e.g., a lever) moves the separators, and thus the tips of the separators, towards the perimeter of the receptacle, and inserts the tips between the bottom and top layers of the flow cell. The separators may continue to be inserted until the top and bottom layers are an appropriate distance apart, e.g., for extraction with tweezers or by hand. FIG. 4A and FIG. 4B are a pair of schematics demonstrating an exemplary method of flow cell disassembly with the exemplary flow cell holder shown in FIG. 1. During disassembly, a clamping force may be applied to or maintained on the bottom layer and top layer of the flow cell in the direction of the one or more alignment features (e.g., in a substantially horizontal direction) to align the bottom and top layers of the flow cell.

For example, to disassemble a flow cell having a bottom layer and a top layer, the flow cell is inserted into the receptacle (408) of the flow cell holder (FIG. 4A). Next, the lever (406) is actuated to position 3 (405), thereby moving the tips of the separators (402) toward the flow cell and applying a wedging force between the bottom layer (409) and the top layer (410) of the flow cell, thereby disassembling the flow cell, as shown in FIG. 4B. By moving the lever from position 1 (403) to position 2 (404), the separators (402) are rotated around their respective pivot points so that the tips are inserted between the bottom layer (409) and the top layer (410) of the flow cell and creating separation at their interface. Further moving the lever from position 2 (404) to position 3 (405) continues moving the separators (402) around their respective pivot points, so that the separator is inserted between the bottom layer (409) and the top layer (410) of the flow cell, further increasing their separation.

In any of the methods described herein, the separators (e.g., the tips of the separators) of the flow cell holder may be vertically disposed at substantially the same height as the interface between the bottom layer and the top layer of the flow cell in the receptacle.

### EXAMPLES

The following examples are included for illustrative purposes only and are not intended to limit the scope of the present disclosure.

### Example 1: Flow Cell Holder for Flow Cell Assembly and Disassembly

This example describes a method for assembling and disassembling the flow cell using the flow cell holder. FIG. 1 shows an exemplary flow cell holder, which includes a receptacle (108), a separation mechanism having three separators (102) operatively linked to a lever (106), two alignment features (101), and an alignment clamp (107). In the exemplary flow cell holder, each separator (102) is attached to the flow cell holder via a pivot point. The actuator includes a lever (106) that is connected to a ring mounted on a bearing. The ring includes posts that pass through gaps in the flow cell holder and attach to the separators (102) at a point away from the pivot point. Moving the lever (106) moves each separator (102) around the pivot point as the posts move in the gaps between Positions 1-3 (103-105, respectively). The bearing may be mounted on a lower plate in the flow cell holder as shown in FIG. 3B and FIG. 4B. The lever (106) in the exemplary flow cell holder can be moved to 3 marked positions (i.e., Position 1 (103), Position 2 (104), and Position 3 (105)), corresponding to three different separator positions. Moving the lever (106) between these three different positions simultaneously moves each of the tips of the separators (102) either substantially towards or away from the receptacle (108) (i.e., towards or away from the perimeter of the receptacle (108)) by moving each separator (102) around the pivot point. The exemplary flow cell includes a nontransparent bottom layer (e.g., (309) in FIG. 3A-FIG. 3B and (409) in FIG. 4A and FIG. 4B) and a patterned, transparent top layer (e.g., (310) in FIG. 3A-FIG. 3B and (410) in FIG. 4A and FIG. 4B), although it is understood that the bottom and top layers may be made of any suitable material and have any suitable properties based on the intended application(s) of the flow cell.

FIG. 3A-FIG. 3C are schematics exemplifying assembly of a flow cell. To assemble a flow cell having a bottom layer (309) and a top layer (310), the bottom layer (309) of the flow cell is first inserted into the receptacle (308) and aligned with the alignment features (301). The lever (306) is then actuated to position 2 (304) to place the tips (e.g., of the separators (302)) over a portion of the bottom layer (309), as shown in FIG. 3A. The top layer (310) of the flow cell is then inserted into the receptacle (308), sandwiching the tips (e.g., of the separators (302)) between the bottom layer (309) and the top layer (310), as shown in FIG. 3B. Next, a clamping force is applied to the flow cell (e.g., the bottom and top layers of the flow cell) towards the alignment features (301) to align the bottom (309) and top (310) layers. Optionally, this clamping force is applied by actuating the alignment clamp (307) to align the bottom (309) and top (310) layers of the flow cell. In particular, the bottom (309) and top (310) layers are aligned relative to each other and also aligned relative to the positions of the three tips (e.g., of the separators (302)). Lastly, as shown in FIG. 3C, the lever (306) is actuated to position 1 (303) to move the separators (302) away from the receptacle (308) and to bring the bottom (309) and top (310) layers of the flow cell into contact, assembling the flow cell.

FIG. 4A and FIG. 4B are schematics exemplifying disassembly of a flow cell. A flow cell that is to be disassembled is placed into the receptacle (408) of a flow cell holder. To disassemble the flow cell having a bottom layer (409) and a top layer (410), the lever (406) is actuated to move the tips (e.g., of the separators (402)) toward the flow cell to apply a wedging force between the bottom layer (409) and the top layer of the flow cell (410), thereby disassembling the flow cell, as shown in FIG. 4B. By moving the lever from position 1 (403) to position 2 (404), the separators (402) are rotated around their respective pivot points so that the tips (e.g., of the separators (402)) are inserted between the bottom layer (409) and the top layer (410) of the flow cell and creating separation at their interface. Further moving the lever from position 2 (404) to position 3 (405) continues rotating the separators (402) around their respective pivot points, so that the separator is inserted between the bottom layer (409) and the top layer (410) of the flow cell, further increasing their separation.

In both assembly and disassembly, aligning the bottom layer (e.g., (309) in FIG. 3A-FIG. 3B and (409) in FIG. 4A and FIG. 4B) and the top layer (e.g., (310) in FIG. 3A-FIG. 3B and (410) in FIG. 4A and FIG. 4B) of the flow cell against the alignment features (e.g., (301) in FIG. 3A-FIG. 3B and (401) in FIG. 4A and FIG. 4B) aligns the flow cell relative to the three separators (e.g., (302) in FIG. 3A-FIG. 3B and (402) in FIG. 4A and FIG. 4B), so that when the lever (e.g., (306) in FIG. 3A-FIG. 3B and (406) in FIG. 4A and FIG. 4B) is actuated, the three separators (e.g., (302) in FIG. 3A-FIG. 3B and (402) in FIG. 4A and FIG. 4B) are removed from or inserted between the bottom (e.g., (309) in FIG. 3A-FIG. 3B and (409) in FIG. 4A and FIG. 4B) and top (e.g., (310) in FIG. 3A-FIG. 3B and (410) in FIG. 4A and FIG. 4B) layers at about the same time. During disassembly, alignment further aids to apply about the same degree of wedging force at about the same time.

The present invention is not intended to be limited in scope to the particular disclosed embodiments, which are provided, for example, to illustrate various aspects of the invention. Various modifications to the compositions and methods described will become apparent from the description and teachings herein. Such variations may be practiced without departing from the true scope and spirit of the disclosure and are intended to fall within the scope of the present disclosure.

What is claimed is:

1. A flow cell holder comprising:
a receptacle configured to hold a flow cell comprising a bottom layer and a top layer; and
a separation mechanism comprising one or more actuators operatively coupled to two or more
separators each having a body with an angled tip,
wherein the two or more separators are disposed about the perimeter of the receptacle, and actuation by the one or more actuators causes the separators to move substantially towards or away from the perimeter of the receptacle in a substantially uniform manner.

2. The flow cell holder of claim 1, wherein the one or more actuators comprise a lever having an effort side and a resistance side, wherein the resistance side of the lever is mechanically coupled to the two or more separators, and movement of the effort side actuates the two or more separators.

3. The flow cell holder of claim 2, wherein each separator is attached to the flow cell holder via a pivot point, and wherein moving the effort side of the lever moves each separator around the pivot point.

4. The flow cell holder of claim 1, wherein the separation mechanism comprises three separators.

5. The flow cell holder of claim 1, wherein the receptacle is between 6 and 9 cm in cross-sectional dimension.

6. The flow cell holder of claim 5, wherein the receptacle is about 7.5 cm in cross-sectional dimension.

7. The flow cell holder of claim 1, wherein the tips are angled between 24° and 36°.

8. The flow cell holder of claim 7, wherein the tips are angled at about 30°

9. The flow cell holder of claim 1, further comprising one or more alignment features disposed at the outer edge of the receptacle.

10. The flow cell holder of claim 9, wherein the flow cell holder comprises two alignment features.

11. The flow cell holder of claim 9, further comprising an alignment clamp configured to apply a clamping force on a flow cell disposed in the receptacle towards the one or more alignment features.

12. A method of assembling a flow cell, wherein the method comprises:
providing the flow cell holder of claim 1;
inserting a bottom layer of the flow cell into the receptacle;
placing the tips over a portion of the bottom layer;
inserting a top layer of the flow cell into the receptacle, wherein the tips are disposed between the bottom layer and the top layer of the flow cell; and
moving the separators away from the receptacle, thereby bringing the bottom layer and the top layer of the flow cell into contact.

13. The method of claim 12, wherein:
the flow cell holder further comprises one or more alignment features disposed at the outer edge of the receptacle; and
after inserting the top layer of the flow cell into the receptacle, a clamping force is applied to the flow cell towards the one or more alignment features.

14. The method of claim 13, wherein:
the flow cell holder further comprises an alignment clamp configured to apply a clamping force on the flow cell disposed in the receptacle towards the one or more alignment features; and
the clamping force is applied by actuating the alignment clamp.

15. A method of disassembling a flow cell, wherein the method comprises:
providing the flow cell holder of claim 1, wherein the receptacle contains the flow cell comprising a bottom layer and a top layer; and
moving the tips toward the flow cell to apply a wedging force between the bottom layer and the top layer of the flow cell, thereby disassembling the flow cell.

16. The method of claim 15, wherein the flow cell holder further comprises one or more alignment features disposed at the outer edge of the receptacle, wherein a clamping force is applied to the flow cell towards the one or more alignment features.

17. The method of claim 15, wherein the method further comprises:
inserting the tips between the bottom layer and the top layer of the flow cell; and
inserting the bodies between the bottom layer and the top layer of the flow cell.

18. The method of claim 12, wherein the tips of the flow cell holder are vertically disposed at substantially the same height as the interface between the bottom layer and the top layer of the flow cell in the receptacle.

19. The method of claim 15, wherein the tips of the flow cell holder are vertically disposed at substantially the same height as the interface between the bottom layer and the top layer of the flow cell in the receptacle.
